(19) United States
(12) Patent Application Publication
(10) Pub. No.: US 2024/0244582 A1
(43) Pub. Date: Jul. 18, 2024

(54) METHOD AND APPARATUS FOR DETERMINING PAGING GROUP, AND COMMUNICATION DEVICE, AND STORAGE MEDIUM

(71) Applicant: Beijing Xiaomi Mobile Software Co., Ltd., Beijing (CN)

(72) Inventor: Yanhua LI, Beijing (CN)

(73) Assignee: Beijing Xiaomi Mobile Software Co., Ltd., Beijing (CN)

(21) Appl. No.: 18/549,626

(22) PCT Filed: Mar. 29, 2021
(86) PCT No.: PCT/CN2021/083604

§ 371 Date: Mar. 29, 2024

(51) Int. Cl. H04W 68/02

(52) U.S. Cl. CPC H04W 68/02

(57) ABSTRACT

Embodiments of the present disclosure provide a method and apparatus for determining a paging group, and a communication device, and a storage medium. The method for determining a paging group provided in the embodiments of the present disclosure is executed by a first network device, and includes negotiating with a second network device to determine paging group auxiliary information, the paging group auxiliary information being used to determine a paging group of a terminal.

### TECHNICAL FIELD

Embodiments of the present disclosure relate to, but are not limited to, the field of wireless communications, and in particular to a method and apparatus for determining a paging group, a communication device, and a storage medium.

### BACKGROUND

In the process of paging a terminal by a network, it is necessary to determine a paging group of the terminal, and an agreement with respect to the paging group needs to be reached between the terminal and a core network and a base station. However, groups supported by different base stations may be inconsistent. Therefore, the terminal fails to find the paging group after switching the base station due to different configurations between base stations or between the base station and the core network, resulting in abnormal paging.

### SUMMARY

The present disclosure provides a method and apparatus for determining a paging group, a communication device and a storage medium.

According to a first aspect of embodiments of the present disclosure, there is provided a method for determining a paging group, which is performed by a first network device, and the method includes:
determining paging group assistance information by negotiating with a second network device, wherein the paging group assistance information is configured to determine a paging group of a terminal.

In some embodiments, the paging group assistance information includes at least one of:
quantity information indicating a total number of groups;
identification information indicating a group identity; and
paging probability information indicating a paging probability corresponding to a group.

In some embodiments, the determining the paging group assistance information by negotiating with the second network device includes:
determining the paging group assistance information with the second network device according to a protocol agreement.

In some embodiments, the method further includes:
determining, according to the protocol agreement, the total number of paging groups by negotiating with the second network device.

In some embodiments, the determining the paging group assistance information with the second network device according to the protocol agreement includes:
determining, according to the protocol agreement, group identity information of a specified type of terminal by negotiating with the second network device.

In some embodiments, the determining the paging group assistance information with the second network device according to the protocol agreement includes:
determining, according to the protocol agreement, the paging probability information corresponding to the paging group of the terminal by negotiating with the second network device.

In some embodiments, the determining the paging group assistance information by negotiating with the second network device includes:
determining, with a non UE-associated signaling, the paging group assistance information by negotiating with the second network device.

In some embodiments, the first network device is a core network device, and the second network device is an access network device; and
the determining, with the non UE-associated signaling, the paging group assistance information by negotiating with the second network device includes:
during establishment of a NG interface between a radio access network and a core network, sending, by the first network device, the paging group assistance information to the second network device through a NG establishment response signaling, wherein the NG establishment response signaling is the non UE-associated signaling.

In some embodiments, the sending, by the first network device, the paging group assistance information to the second network device through the NG establishment response signaling includes:
sending, by the first network device, the paging group assistance information to a plurality of access network devices in a Tracking Area (TA) or a Routing Area (RA) of the first network device through the NG establishment response signaling.

In some embodiments, the first network device is an access network device, and the second network device is a core network device;
the determining, with the non UE-associated signaling, the paging group assistance information by negotiating with the second network device includes:
during establishment of a NG interface, sending, by the first network device, the paging group assistance information to the second network device by using a NG establishment request signaling, wherein the NG establishment request signaling is the non UE-associated signaling.

In some embodiments, the first network device includes an access network device accessed by the terminal after switching a cell, and the second network device is an access network device accessed by the terminal before switching the cell.

In some embodiments, the determining the paging group assistance information by negotiating with the second network device includes:
determining, by the first network device, the paging group assistance information according to a switch request message sent by the second network device, wherein the paging group assistance information is carried by the switch request message.

In some embodiments, the switch request message includes:
the paging group assistance information reported by the terminal that is received by the second network device;
and/or
the paging group assistance information obtained by the second network device from a core network device.

In some embodiments, the first network device is an access network device accessed by an inactive terminal after reselecting a cell, and the second network device is an anchor access network device accessed by the inactive terminal before reselecting the cell.

In some embodiments, the determining the paging group assistance information by negotiating with the second network device includes:
determining, by the first network device, the paging group assistance information according to context response information of the terminal sent by the second network device, wherein the paging group assistance information is carried in the context response information of the terminal.

In some embodiments, the first network device is an access network device accessed by the terminal after switching a cell, and the second network device is a core network device.

In some embodiments, the determining the paging group assistance information by negotiating with the second network device includes:
sending, by the first network device, a path switch request to the second network device, wherein the path switch request is configured to request the second network device to send the paging group assistance information; and
receiving, by the first network device, a path switch response sent, according to the path switch request, by the second network device, wherein the paging group assistance information is carried in the path switch response.

In some embodiments, the path switch request includes flag information requesting the paging group assistance information.

In some embodiments, the paging group assistance information is carried in the path switch response of the core network device based on the protocol agreement;
or
the paging group assistance information is carried in the path switch response of the core network device based on the flag information.

According to a second aspect of embodiments of the present disclosure, there is provided an apparatus for determining a paging group, and the apparatus includes:
a transceiver module, configured to determine paging group assistance information by negotiating with a second network device, wherein the paging group assistance information is configured to determine a paging group of a terminal.

In some embodiments, the paging group assistance information includes at least one of:
quantity information indicating a total number of groups;
identification information indicating a group identity; and
paging probability information indicating a paging probability corresponding to a group.

In some embodiments, the transceiver module is specifically configured to:
determine the paging group assistance information with the second network device according to a protocol agreement.

In some embodiments, the transceiver module is specifically configured to:
determine, according to the protocol agreement, the total number of paging groups by negotiating with the second network device.

In some embodiments, the transceiver module is specifically configured to:
determine, according to the protocol agreement, group identity information of a specified type of terminal by negotiating with the second network device.

In some embodiments, the transceiver module is specifically configured to:
determine, according to the protocol agreement, the paging probability information corresponding to the paging group of the terminal by negotiating with the second network device.

In some embodiments, the transceiver module is specifically configured to:
determine, with a non UE-associated signaling, the paging group assistance information by negotiating with the second network device.

In some embodiments, the apparatus is a core network device, and the second network device is an access network device; and
the transceiver module is further configured to:
during establishment of a NG interface between a radio access network and a core network, send the paging group assistance information to the second network device through a NG establishment response signaling, wherein the NG establishment response signaling is the non UE-associated signaling.

In some embodiments, the transceiver module is further configured to:
send the paging group assistance information to a plurality of access network devices in a Tracking Area (TA) or a Routing Area (RA) of the apparatus through a NG establishment response signaling.

In some embodiments, the apparatus is an access network device, and the second network device is a core network device; and
the transceiver module is further configured to:
during establishment of a NG interface, send the paging group assistance information to the second network device by using a NG establishment request signaling, wherein the NG establishment request signaling is the non UE-associated signaling.

In some embodiments, the apparatus includes an access network device accessed by the terminal after switching a cell, and the second network device is an access network device accessed by the terminal before switching the cell.

In some embodiments, the transceiver module is further configured to:
determine the paging group assistance information according to a switch request message sent by the second network device, wherein the paging group assistance information is carried by the switch request message.

In some embodiments, the switch request message includes:
the paging group assistance information reported by the terminal that is received by the second network device;
and/or
the paging group assistance information obtained by the second network device from a core network device.

In some embodiments, the apparatus is an access network device accessed by an inactive terminal after reselecting a cell, and the second network device is an anchor access network device accessed by the inactive terminal before reselecting the cell.

In some embodiments, the transceiver module is further configured to:
determine the paging group assistance information according to context response information of the terminal sent by the second network device, wherein the paging group assistance information is carried in the context response information of the terminal.

In some embodiments, the apparatus is an access network device accessed by the terminal after switching a cell, and the second network device is a core network device.

In some embodiments, the transceiver module is further configured to:
send a path switch request to the second network device, wherein the path switch request is configured to request the second network device to send the paging group assistance information; and
a receiving sub-module, configured to receive a path switch response sent, according to the path switch request, by the second network device, wherein the paging group assistance information is carried in the path switch response.

In some embodiments, the path switch request includes flag information requesting the paging group assistance information.

In some embodiments, the paging group assistance information is carried in the path switch response of the core network device based on the protocol agreement;
or
the paging group assistance information is carried in the path switch response of the core network device based on the flag information.

According to a third aspect of embodiments of the present disclosure, there is provided a communication device, and the communication device includes at least: a processor and an interface circuit;
the interface circuit is configured to receive code instructions and transmit them to the processor; and
the processor is configured to run the code instructions to perform steps in any one of the methods as described above.

According to a fourth aspect of embodiments of the present disclosure, there is provided a computer-readable storage medium having computer-executable instructions stored thereon, which are configured to, when executed, implement steps in any one of the methods as described above.

In the method for determining the paging group provided by embodiments of the present disclosure, a consensus is reached on the paging group of the terminal by means of the negotiation of the paging group assistance information between the network devices, so that a case that the paging error occurs due to the inconsistent paging groups of the terminal between the network devices such as the base stations or the core networks is reduced.

### BRIEF DESCRIPTION OF THE DRAWINGS

The accompanying drawings here, which are incorporated in and constitute a part of this specification, illustrate embodiments consistent with the present disclosure and together with the description serve to explain principles of embodiments of the present disclosure.

FIG. 1 is a schematic structural diagram showing a wireless communication system according to an embodiment of the present disclosure;

FIG. 2 is a first flowchart showing a method for determining a paging group according to an embodiment of the present disclosure;

FIG. 3 is a second flowchart showing a method for determining a paging group according to an embodiment of the present disclosure;

FIG. 4 is a third flowchart showing a method for determining a paging group according to an embodiment of the present disclosure;

FIG. 5 is a fourth flowchart showing a method for determining a paging group according to an embodiment of the present disclosure;

FIG. 6 is a fifth flowchart showing a method for determining a paging group according to an embodiment of the present disclosure;

FIG. 7 is a structural block diagram showing an apparatus for determining a paging group according to an embodiment of the present disclosure;

FIG. 8 is a first structural schematic diagram showing a communication device according to an embodiment of the present disclosure; and

FIG. 9 is a second structural schematic diagram showing a communication device according to an embodiment of the present disclosure.

### DETAILED DESCRIPTION

Reference will now be made in detail to embodiments, examples of which are illustrated in the accompanying drawings. The following description refers to the accompanying drawings in which the same numbers in different drawings represent the same or similar elements unless otherwise represented. The implementations set forth in the following description of the embodiments do not represent all implementations consistent with the present disclosure. Instead, they are merely examples of apparatuses and methods consistent with some aspects of the embodiments of the present disclosure as recited in the appended claims.

The terms used in the embodiments of the present disclosure are merely for the purpose of describing particular embodiments and are not intended to limit the embodiments of the present disclosure. As used in the embodiments of the present disclosure and the appended claims, the singular forms “a” and “said” are intended to include the plural forms as well, unless the context clearly indicates otherwise. It should also be understood that the term “and/or” as used herein refers to and includes any or all possible combinations of one or more of the associated listed items.

It should be understood that, although the terms first, second, third, etc. may be used in embodiments of the present disclosure to describe various information, such information should not be limited to these terms. These terms are only used to distinguish the same type of information from each other. For example, without departing from the scope of embodiments of the present disclosure, first information may also be referred to as second information, and similarly, the second information may also be referred to as the first information. Depending on the context, the word “if” as used herein can be interpreted as “upon” or “when” or “in response to determination”.

In order to better describe any embodiment of the present disclosure, an embodiment of the present disclosure takes an application scenario of access control as an example for illustration.

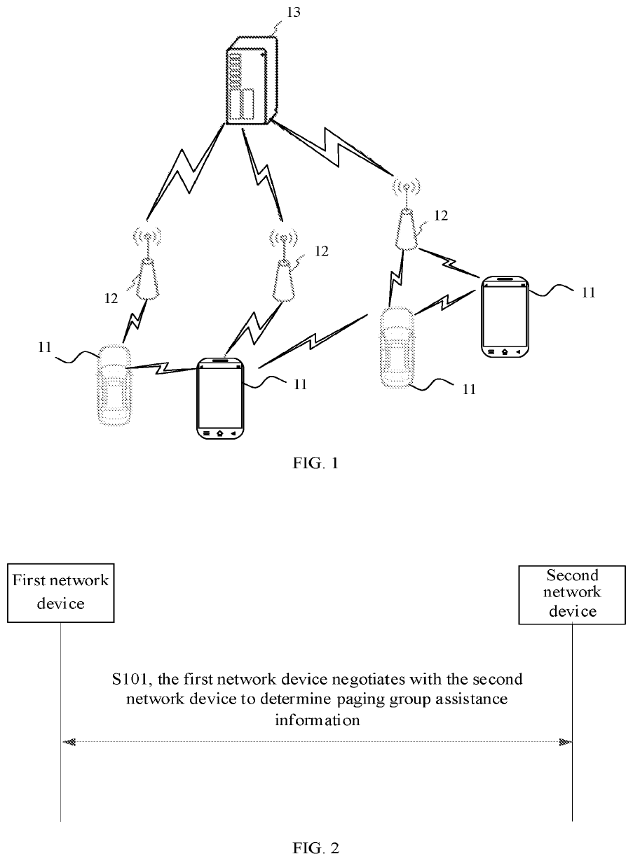

Reference is made to FIG. 1, which shows a schematic structural diagram of a wireless communication system provided by an embodiment of the present disclosure. As illustrated in FIG. 1, the wireless communication system is a communication system based on cellar mobile communication technologies. The wireless communication system may include several terminals 11 and several base stations 12.

The terminal 11 may refer to a device that provides voice and/or data connectivity to a user. The terminal 11 may communicate with one or more core networks via a Radio Access Network (RAN). The terminal 11 may be an Internet of Things terminal, such as a sensor device, a mobile phone (or caller “cellular” phone) and a computer with the Internet of Things terminal, for example, may be a fixed, portable, pocket-sized, handheld, built-in computer or vehicle-mounted device. For example, the user equipment may be a station (STA), a subscriber unit, a subscriber station, a mobile station, a mobile, a remote station, an access point, a remote terminal, an access terminal, a user terminal, a user agent, a user device, or a user equipment. Or, the terminal 11 may also be a device of an unmanned aerial vehicle. Or, the terminal 11 may also be a vehicle-mounted device, such as a trip computer with a wireless communication function, or a wireless terminal connected to an external trip computer. Or, the terminal 11 may also be a roadside device, such as a streetlight, a signal light or another roadside device with a wireless communication function.

The base station 12 can be a network-side device in a wireless communication system. The wireless communication system can be a 4th generation mobile communication (4G) system, also known as a Long Term Evolution (LTE) system. Or, the wireless communication system may also be a 5G system, also known as a New Radio (NR) system or a 5G NR system. Or, the wireless communication system may also be a next-generation system of 5G system. An access network in the 5G system can be referred to as a New Generation-Radio Access Network (NG-RAN).

The base station 12 can be an evolved NodeB (eNB) in the 4G system. Or, the base station 12 may also be a gNB with a central distributed architecture in the 5G system. When the base station 12 adopts the central distributed architecture, it usually includes a Central Unit (CU) and at least two Distributed Units (DUs). The CU is provided with a protocol stack of a Packet Data Convergence Protocol (PDCP) layer, a Radio Link Control (RLC) layer, and a Media Access Control (MAC) layer. The DU is provided with a protocol stack of a Physical (PHY) layer. A specific implementation of the base station 12 is not limited in embodiments of the present disclosure.

A wireless connection can be established between the base station 12 and the terminal 11 through a radio air interface. In different implementations, the radio air interface is a radio air interface based on a 4th generation mobile communication network technology (4G) standard. Or, the radio air interface is a radio air interface based on a 5th generation mobile communication network technology (5G) standard, such as the NR. Or, the radio air interface may also be a radio air interface based on a 5G next-generation mobile communication network technology standard.

In some embodiments, an End to End (E2E) connection may also be established between the terminals 11, such as a vehicle to vehicle (V2V) communication, a vehicle to infrastructure (V2I) communication and a vehicle to pedestrian (V2P) communication in a vehicle to everything (V2X) communication, and other scenarios.

In some embodiments, the above wireless communication system may further include a network management device 13.

The several base stations 12 are connected to the network management device 13, respectively. The network management device 13 can be a core network device in the wireless communication system. For example, the network management device 13 can be a Mobility Management Entity (MME) in an Evolved Packet Core (EPC) network. Or, the network management device may also be another core network device, such as a Serving Gateway (SGW), a Public Data Network Gateway (PGW), a Policy And Charging Rules Function (PCRF) unit or a Home Subscriber Server (HSS). An implementation form of the network management device 13 is not limited in embodiments of the present disclosure.

For a paging group of a terminal, a probability grouping mechanism may be adopted. That is, a paging probability is negotiated between the terminal and a core network in advance, and a base station broadcasts a relationship with the group. In this way, the terminal can determine the paging group. When a paging message arrives at the base station from the core network, the core network will also notify the base station of the terminal for the base station to determine the group of the terminal. When the core network does not provide this parameter, the terminal selects a default group. In this way, the three network elements of the terminal, the base station and the core network confirm the consistent group. When a grouping scheme is used in combination with a Wake-up Signal (WUS), it becomes a problem of determining a wake-up signal group of the terminal.

In some embodiments, the group of the terminal is further extended. Both the network and the terminal must obtain some synchronization parameters, and then determine the group of the terminal according to negotiated rules. In this way, the consistency of network and terminal understanding is achieved.

For a manner to allocate a group identity based on the RAN, a basic operating idea is as follows.

The base station allocates the group identity, and sends it to the terminal before the terminal is released. For an idle user, the group identity will be sent to the core network for maintenance, to be returned to a base station which is about to initiate the paging by the core network when initiating the paging in the next time, so as to be used as a reference for initiating the paging. For an inactive user, the group identity will be transferred, as part of the UE context, from an anchor base station to a non-anchor base station for maintenance, to be used as a reference for initiating the paging from the non-anchor base station in the next time. The non-anchor base station may also reallocate the group identity. However, if groups supported by the base stations are inconsistent, there will be problems. For example, the terminal reselects to a base station that supports a smaller number of groups, such as reselecting to a base station that supports two groups (the group identities include: medium and low) from a base station that supports three groups (the group identities include: high, medium and low), and the group which the terminal previously belongs to that is allocated by the original base station is the high group, and the problem of failing to find the group may occur since the new base station only supports the medium and low groups. For a manner to allocate the group by the core network, the problem that an error is caused due to the inconsistency between the group ID allocated by the core network and the group supported by the base station may also occur.

In order to avoid the above problems, it may be considered to negotiate certain assistance information between base stations and between the base station and the core network. As shown in FIG. 2, embodiments of the present disclosure provide a method for determining a paging group, and the method is performed by a first network device. The method includes:
in step S101, the first network device negotiates with a second network device to determine paging group assistance information, and the paging group assistance information is configured to determine a paging group of a terminal.

For the terminal, the network device can specify a corresponding paging group, and initiate the paging for the terminal according to the paging group. Here, the network device may be a core network device, or an access network device, such as a base station.

If different network devices have inconsistent paging groups of the terminal, there may be a problem of abnormal paging. Therefore, in embodiments of the present disclosure, the paging group assistance information is determined through the negotiation between the network devices, and the paging group assistance information is configured to determine the paging group of the terminal.

In this way, different network devices can negotiate to determine the consistent paging group assistance information, and use the unified paging group for the terminal, so a case that the paging error is caused due to the inconsistent paging groups of the same terminal at different network devices will not occur.

In some embodiments, the paging group assistance information includes at least one of:
quantity information indicating a total number of groups;
identification information indicating a group identity; and
paging probability information indicating a paging probability corresponding to a group.

In embodiments of the present disclosure, the terminal and the core network can determine the paging group of the terminal through the negotiated paging probability between the terminal and the core network. When a paging message arrives at the access network from the core network, the core network can notify the access network of the paging probability corresponding to the terminal for the access network device, such as the base station, to determine the group of the terminal.

Therefore, for the paging group assistance information indicating the paging group of the terminal, corresponding paging probability information may be included. In this way, the unified paging group assistance information can be determined, by determining the paging probability information through the negotiation, between the core network device and the access network device, as well as the base stations of the access network, etc.

In addition, the quantity information regarding the total number of paging groups may also be negotiated between the network devices. For example, if the total number is three groups, the involved network devices in a paging process uniformly determine that there are three groups, and can select one of them as the paging group of the terminal. In this way, a case that when the number of paging groups allocated by one base station is three, and the number of paging groups allocated by another base station is two, the terminal cannot find the corresponding group after the switching from a first base station to a second base station can be avoided.

Note that, the identification information of the paging group of the terminal device can also be determined directly through the negotiation between the network devices, so as to determine the unified group for the terminal without leading to the inconsistent groups.

In some embodiments, the determining the paging group assistance information by negotiating with the second network device includes:
determining the paging group assistance information with the second network device according to a protocol agreement.

The negotiation action may be determined by means of the pre-agreed protocol. For example, the paging group assistance information jointly determined by the first network device and the second network device is agreed in the protocol.

A type of the paging group assistance information may be agreed in the protocol, for example, the total number of paging groups, a group identity or a group probability, etc.

As shown in FIG. 3, embodiments of the present disclosure provide a method for determining a paging group, which is performed by a first network device. The method includes:
in step S201, according to the protocol agreement, the first network device determines the total number of paging groups by negotiating with the second network device.

In embodiments of the present disclosure, the type of the paging group assistance information negotiated between the first network device and the second network device may be determined as the total number of paging groups according to the protocol agreement.

The first network device and the second network device may determine, based on the protocol agreement, the total number of groups by exchanging information.

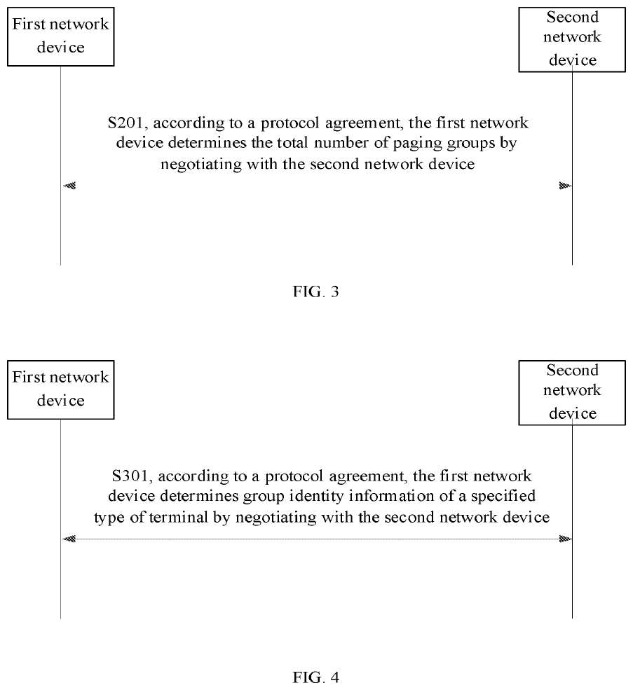

As shown in FIG. 4, embodiments of the present disclosure provide a method for determining a paging group, which is performed by a first network device. The method includes:
in step S301, according to the protocol agreement, the first network device determines group identity information of a specified type of terminal by negotiating with the second network device.

In embodiments of the present disclosure, the type of the paging group assistance information negotiated between the first network device and the second network device may be determined as the group identity information according to the protocol agreement.

The first network device and the second network device may determine, based on the protocol agreement, the group identity information of the specified type of terminal (e.g., group identity information of a specified Redcap terminal) by exchanging the information.

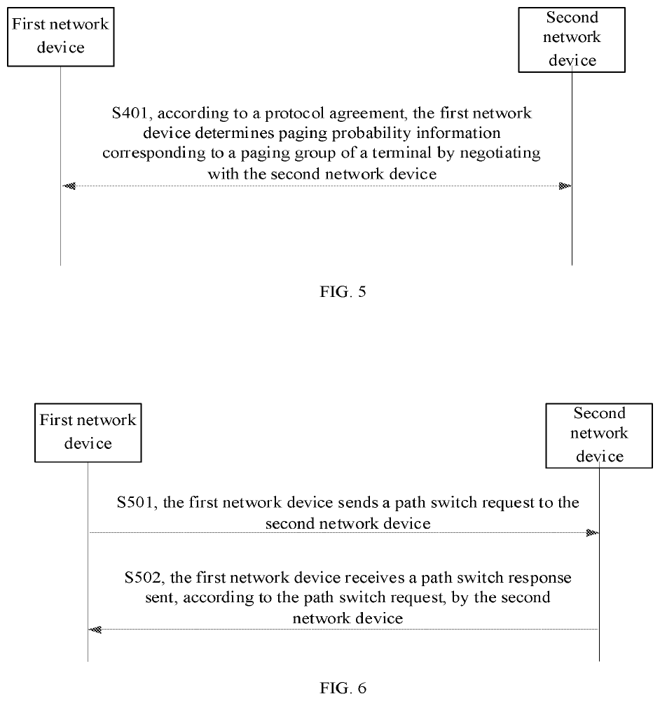

As shown in FIG. 5, embodiments of the present disclosure provide a method for determining a paging group, which is performed by a first network device. The method includes:
in step S401, according to the protocol agreement, the first network device determines paging probability information corresponding to the paging group of the terminal by negotiating with the second network device.

In embodiments of the present disclosure, the type of the paging group assistance information negotiated between the first network device and the second network device may be determined as the paging probability information according to the protocol agreement.

The first network device and the second network device can determine, based on the protocol agreement, the paging probability information by exchanging the information, or determine the paging probability information of the specified type of terminal, for example, a paging probability of the Redcap terminal is specified as a low probability, or a group corresponding to the paging probability of the Redcap terminal is specified as a first group or group 0, etc.

Note that, the paging probability information of the specified type of terminal nay also be directly agreed through the protocol, for example, the paging probability of the Redcap terminal with an industrial sensor being a low probability is agreed in the protocol, and so on.

In some embodiments, the determining the paging group assistance information by negotiating with the second network device includes:
determining, with a non UE-associated signaling, the paging group assistance information by negotiating with the second network device.

Here, the negotiation of the paging group assistance information between different network devices may be implemented by using the non UE-associated signaling communicated between the network devices.

In some embodiments, the first network device is a core network device, and the second network device is an access network device; and
the determining, with the non UE-associated signaling, the paging group assistance information by negotiating with the second network device includes:
during establishment of a NO interface (the interface between the radio access network and the core network), the first network device sends the paging group assistance information to the second network device through a NG establishment response signaling, and the NO establishment response signaling is the non UE-associated signaling.

That is to say, the first network device may carry the paging group assistance information in the NG establishment response signaling during the establishment of the NO interface, and the negotiation of the paging group assistance information between different network devices is implemented through the NG establishment response signaling.

In some embodiments, the sending, by the first network device, the paging group assistance information to the second network device through the NG establishment response signaling includes:
the first network device sends, through the NO establishment response signaling, the paging group assistance information to a plurality of access network devices in a TA or a RA of the first network device.

For the NR system, during the establishment of the NG interface, the core network device and the access network device can carry the paging group assistance information through the NG establishment response information. The core network device or an access network device can send the paging group assistance information to each other access network device in the same TA or RA, so that the network devices in the same TA or RA all determine the unified paging group.

In some embodiments, the first network device is the access network device, and the second network device is the core network device; and
the determining, with the non UE-associated signaling, the paging group assistance information by negotiating with the second network device includes:
during the establishment of the NG interface, the first network device sends the paging group assistance information to the second network device by using a NG establishment request signaling, and the NG establishment request signaling is the non UE-associated signaling.

In embodiments of the present disclosure, the NG interface establishment signaling belongs to the non UE-associated signaling between the network devices, that is, the above-mentioned non UE-associated signaling. A characteristic of this signaling is that it is not related to a single terminal. During the establishment of the NG interface, the access network device may send the NG establishment request signaling to the core network device to request the establishment of the NG interface. Therefore, the access network device may carry the paging group assistance information in the NG interface request signaling and send it to the core network device, thereby achieving the negotiation of the paging group assistance information between the access network device and the core network device.

As an embodiment, the network-side device may also obtain the paging group assistance information from the core network device through an initial UE context establishment/modification message, etc., which is a UE-associated signaling.

In some embodiments, the first network device includes an access network device accessed by the terminal after switching a cell, and the second network device is an access network device accessed by the terminal before switching the cell.

In embodiments of the present disclosure, when the terminal switches the cell, the access network devices such as the base stations accessed before and after the switch can determine the paging group assistance information of the terminal by means of the negotiation method in the above embodiments, so that the terminal can be configured with the unified paging group before and after switching the cell.

Embodiments of the present disclosure provide a method for determining a paging group, which is performed by a first network device, and the method includes:
the first network device determines the paging group assistance information according to a switch request message sent by the second network device, and the switch request message carries the paging group assistance information.

In a process that the terminal switches the cell, the base station accessed by the terminal before the switch needs to send the switch request message to a target base station to be switched to, that is, an original access network device in an access process needs to send the switch request message to a target access network device. Therefore, the paging group assistance information can be carried in the switch request message here, so as to achieve the purpose of determining the paging group of the terminal through the negotiation between the first network device, that is, the original access network device, and the second network device, that is, the target access network device.

In some embodiments, the switch request message includes:
the paging group assistance information reported by the terminal that is received by the second network device;
and/or
the paging group assistance information obtained by the second network device from the core network device.

In embodiments of the present disclosure, the first network device determines the paging group assistance information from the switch request message sent by the second network device. The paging group assistance information sent by the second network device is obtained from the terminal or from the core network device.

As an embodiment, the paging group assistance information sent by the second network device may be obtained from the terminal through the terminal capability reporting; and the paging group assistance information sent by the second network device may be obtained from the core network device through the initial UE context establishment/modification message and other messages.

In some embodiments, the first network device is an access network device accessed by an inactive terminal after reselecting a cell, and the second network device is an anchor access network device of the inactive terminal before performing the cell reselection.

For the inactive terminal, the reselected target base station can obtain the paging group assistance information from the anchor base station during the cell reselection.

In some embodiments, the determining the paging group assistance information by negotiating with the second network device includes:
the first network device determines the paging group assistance information according to context response information of the terminal sent by the second network device, and the paging group assistance information is carried in the context response information of the terminal.

In a process that the terminal performs the cell reselection or the cell switch, the first network device may carry the paging group assistance information in the context response information of the terminal to notify the second network device, so that the terminal can be configured with the unified paging group after the cell switch.

In some embodiments, the first network device is an access network device accessed by the terminal after switching the cell, and the second network device is the core network device.

In a scenario where the terminal performs the cell switch, the access network device after the completion of the cell switch, such as the base station, can also obtain the paging group assistance information from the core network device, so that the terminal can be configured with the unified paging group by an access network device of a new cell after the terminal is switched to the new cell.

As shown in FIG. 6, embodiments of the present disclosure provide a method for determining a paging group, which is performed by a first network device, and the method includes:
in step S501, the first network device sends a path switch request to the second network device, and the path switch request is configured to request the second network device to send the paging group assistance information; and
in step S502, the first network device receives a path switch response sent, according to the path switch request, by the second network device, and the paging group assistance information is carried in the path switch response.

In the process that the terminal performs the cell switch, the access network device needs to switch the path through the core network, and the access network device needs to send the path switch request to the core network device. The core network device sends a corresponding path switch response to the access network device based on the path switch request.

Therefore, the request for the paging group assistance information may be, by the first network device (i.e., the access network device), carried in the path switch request and sent to the second network device (the core network device). The second network device carries the configured paging group assistance information in the path switch response and sends it to the first network device, thereby completing the acknowledgment of the paging group assistance information between the first network device and the second network device.

In some embodiments, the path switch request includes flag information requesting the paging group assistance information.

In embodiments of the present disclosure, when the first network device sends the path switch request to the second network device, it can carry the flag information in the path switch request to identify the request for the paging group assistance information if there is a need to negotiate the paging group assistance information. For example, a character bit is used to indicate whether to request the paging group assistance information. When the character bit is 1, it means to request the paging group assistance information, and when the character bit is 0, it means that there is no need for the second network device to carry the paging group assistance information in the response message.

In some embodiments, the paging group assistance information is carried in the path switch response of the core network device based on the protocol agreement; or
the paging group assistance information is carried in the path switch response of the core network device based on the flag information.

In embodiments of the present disclosure, if the first network device needs to obtain the paging group assistance information from the second network device, the second network device may carry the paging group assistance information in the path switch response based on the protocol agreement. Alternatively, when the path switch request sent by the first network device that is received by the second network device contains the flag information indicating that the paging group assistance information is requested, the second network device may carry the paging group assistance information in the path switch response.

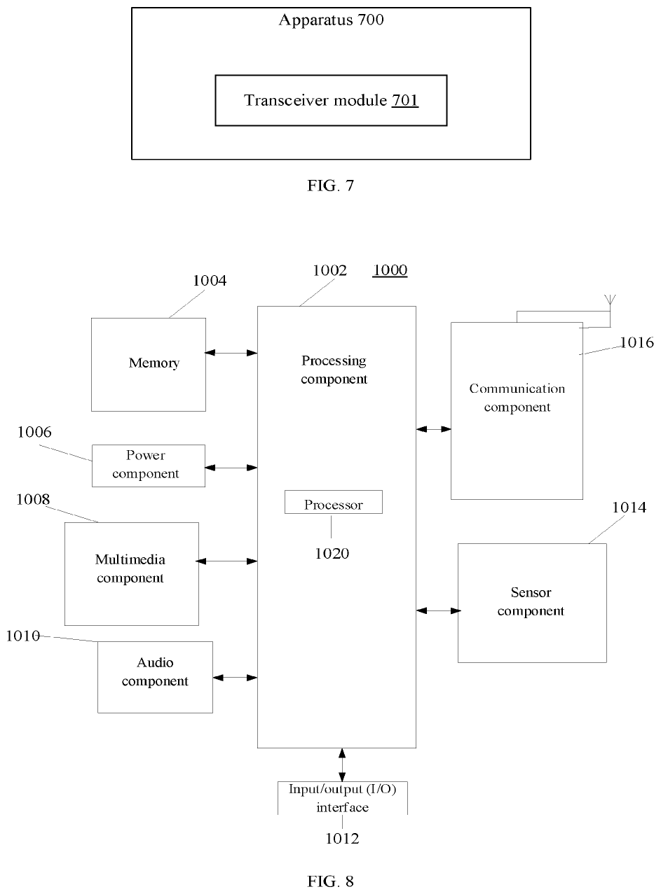

As shown in FIG. 7, embodiments of the present disclosure provide an apparatus 700 for determining a paging group, including:
a transceiver module 701, configured to determine paging group assistance information by negotiating with a second network device, wherein the paging group assistance information is configured to determine a paging group of a terminal.

In some embodiments, the paging group assistance information includes at least one of:
quantity information indicating a total number of groups;
identification information indicating a group identity; and
paging probability information indicating a paging probability corresponding to a group.

In some embodiments, the transceiver module is specifically configured to:
determine the paging group assistance information with the second network device according to a protocol agreement.

In some embodiments, the transceiver module is specifically configured to:
determine, according to the protocol agreement, a total number of paging groups by negotiating with the second network device.

In some embodiments, the transceiver module is specifically configured to:
determine, according to the protocol agreement, group identity information of a specified type of terminal by negotiating with the second network device.

In some embodiments, the transceiver module is specifically configured to:
determine, according to the protocol agreement, paging probability information corresponding to the paging group of the terminal by negotiating with the second network device.

In some embodiments, the transceiver module is specifically configured to:
determine, with a non UE-associated signaling, the paging group assistance information by negotiating with the second network device.

In some embodiments, the apparatus is a core network device, and the second network device is an access network device; and
the transceiver module is further configured to:
during establishment of a NG interface between a radio access network and a core network, send the paging group assistance information to the second network device through a NG establishment response signaling, wherein the NG establishment response signaling is the non UE-associated signaling.

In some embodiments, the transceiver module is further configured to:
send the paging group assistance information to a plurality of access network devices in a Tracking Area (TA) or a Routing Area (RA) of the apparatus through a NG establishment response signaling.

In some embodiments, the apparatus is an access network device, and the second network device is a core network device; and
the transceiver module is further configured to: during establishment of a NG interface, send the paging group assistance information to the second network device by using a NG establishment request signaling, wherein the NG establishment request signaling is the Non UE-associated signaling.

In some embodiments, the apparatus includes an access network device accessed by the terminal after switching a cell, and the second network device is an access network device accessed by the terminal before switching the cell.

In some embodiments, the transceiver module is further configured to:
determine the paging group assistance information according to a switch request message sent by the second network device, wherein the paging group assistance information is carried by the switch request message.

In some embodiments, the switch request message includes:
the paging group assistance information reported by the terminal that is received by the second network device;
and/or
the paging group assistance information obtained by the second network device from a core network device.

As an embodiment, the paging group assistance information sent by the second network device may be obtained from the terminal through the terminal capability reporting; and the paging group assistance information sent by the second network device may be obtained from the core network device through the initial UE context establishment/modification message and other messages.

In some embodiments, the apparatus is an access network device accessed by an inactive terminal after reselecting a cell, and the second network device is an anchor access network device accessed by the inactive terminal before reselecting the cell.

In some embodiments, the transceiver module is further configured to:
determine the paging group assistance information according to context response information of the terminal sent by the second network device, wherein the paging group assistance information is carried in the context response information of the terminal.

In some embodiments, the apparatus is an access network device accessed by the terminal after switching a cell, and the second network device is a core network device.

In some embodiments, the transceiver module is further configured to:
send a path switch request to the second network device, wherein the path switch request is configured to request the second network device to send the paging group assistance information; and
a receiving sub-module is configured to receive a path switch response sent, according to the path switch request, by the second network device, wherein the paging group assistance information is carried in the path switch response.

In some embodiments, the path switch request includes flag information requesting the paging group assistance information.

In some embodiments, the paging group assistance information is carried in the path switch response of the core network device based on a protocol agreement;
or
the paging group assistance information is carried in the path switch response of the core network device based on the flag information.

Regarding the apparatus in the foregoing embodiments, a specific manner in which each module executes operations has been described in detail in embodiments related to the method, and will not be described in detail here.

FIG. 8 is a structural block diagram of a communication device provided by an embodiment of the present disclosure. The communication device may be a terminal. For example, the communication device 1000 may be a mobile phone, a computer, a digital broadcast user device, a messaging device, a gaming console, a tablet device, a medical device, an exercise device, a personal digital assistant, etc.

Referring to FIG. 8, the communication device 1000 may include at least one of the following components: a processing component 1002, a memory 1004, a power component 1006, a multimedia component 1008, an audio component 1100, an input/output (I/O) interface 1012, a sensor component 1014, and a communication component 1016.

The processing component 1002 typically controls overall operations of the communication device 1000, such as the operations associated with display, telephone calls, data communications, camera operations, and recording operations. The processing component 1002 may include at least one processor 1020 to execute instructions to perform all or part of the steps in the above described methods. Moreover, the processing component 1002 may include at least one module which facilitate the interaction between the processing component 1002 and other components. For instance, the processing component 1002 may include a multimedia module to facilitate the interaction between the multimedia component 1008 and the processing component 1002.

The memory 1004 is configured to store various types of data to support the operation of the communication device 1000. Examples of such data include instructions for any applications or methods operated on the communication device 1000, contact data, phonebook data, messages, pictures, video, etc. The memory 1004 may be implemented using any type of volatile or non-volatile memory apparatuses, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The power component 1006 provides power to various components of the communication device 1000. The power component 1006 may include a power management system, at least one power source, and any other components associated with the generation, management, and distribution of power in the communication device 1000.

The multimedia component 1008 includes a screen providing an output interface between the communication device 1000 and the user. In some embodiments, the screen may include a liquid crystal display (LCD) and a touch panel (TP). If the screen includes the touch panel, the screen may be implemented as a touch screen to receive input signals from the user. The touch panel includes at least one touch sensor to sense touches, swipes, and gestures on the touch panel. The touch sensors may not only sense a boundary of a touch or swipe action, but also sense a wake-up time and a pressure associated with the touch or swipe action. In some embodiments, the multimedia component 1008 includes a front camera and/or a rear camera. The front camera and the rear camera may receive an external multimedia datum while the communication device 1000 is in an operation mode, such as a photographing mode or a video mode. Each of the front camera and the rear camera may be a fixed optical lens system or have focus and optical zoom capability.

The audio component 1100 is configured to output and/or input audio signals. For example, the audio component 1100 includes a microphone (MIC) configured to receive an external audio signal when the communication device 1000 is in an operation mode, such as a call mode, a recording mode, and a voice recognition mode. The received audio signal may be further stored in the memory 1004 or transmitted via the communication component 1016. In some embodiments, the audio component 1100 further includes a speaker to output audio signals.

The I/O interface 1012 provides an interface between the processing component 1002 and peripheral interface modules, such as a keyboard, a click wheel, buttons, and the like. The buttons may include, but are not limited to, a home button, a volume button, a starting button, and a locking button.

The sensor component 1014 includes at least one sensor to provide status assessments of various aspects of the communication device 100). For instance, the sensor component 1014 may detect an open/closed status of the communication device 100, relative positioning of components, e.g., the display and the keypad, of the communication device 1000, a change in position of the communication device 1000 or a component of the communication device 1000, a presence or absence of user contact with the communication device 1000, an orientation or an acceleration/deceleration of the communication device 1000, and a change in temperature of the communication device 100. The sensor component 1014 may include a proximity sensor configured to detect the presence of nearby objects without any physical contact. The sensor component 1014 may also include a light sensor, such as a CMOS or CCD image sensor, for use in imaging applications. In some embodiments, the sensor component 1014 may also include an accelerometer sensor, a gyroscope sensor, a magnetic sensor, a pressure sensor, or a temperature sensor.

The communication component 1016 is configured to facilitate communication, wired or wirelessly, between the communication device 1000 and other devices. The communication device 1000 may access a wireless network based on a communication standard, such as WiFi, 2G, or 3G, or a combination thereof. In an embodiment, the communication component 1016 receives a broadcast signal or broadcast associated information from an external broadcast management system via a broadcast channel. In an embodiment, the communication component 1016 further includes a near field communication (NFC) module to facilitate short-range communications. For example, the NFC module may be implemented based on a radio frequency identification (RFID) technology, an infrared data association (IrDA) technology, an ultra-wideband (UWB) technology, a Bluetooth (BT) technology, and other technologies.

In an embodiment of the present disclosure, the communication device 1000 may be implemented with at least one application specific integrated circuit (ASIC), digital signal processor (DSP), digital signal processing device (DSPD), programmable logic device (PLD), field programmable gate array (FPGA), controller, micro-controller, microprocessor, or other electronic components, for performing the above described methods.

In an embodiment of the present disclosure, there is further provided a non-transitory computer readable storage medium including instructions, such as the memory 1004 including instructions, the above instructions may be executed by the processor 1020 in the communication device 1000 for performing the above-described methods. For example, the non-transitory computer-readable storage medium may be a ROM, a Random Access Memory (RAM), a CD-ROM, a magnetic tape, a floppy disc, an optical data storage device, and the like.

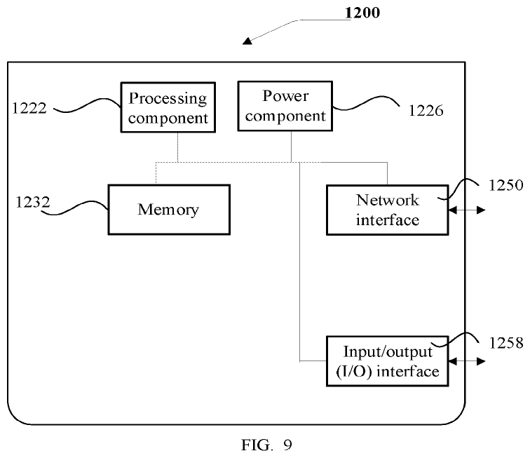

As shown in FIG. 9, an embodiment of the present disclosure shows a structure of another communication device. The communication device may be the base station involved in embodiments of the present disclosure. For example, the communication device 1200 may be provided as a network device. Referring to FIG. 9, the communication device 1200 includes a processing component 1222, which further includes at least one processor and a memory resource represented by a memory 1232 for storing instructions executable by the processing component 1222, such as an application program. The application program stored in the memory 1232 may include one or more modules, each corresponding to a set of instructions. In addition, the processing component 1222 is configured to execute the instructions to execute any of the aforementioned methods applied in the communication device.

The communication device 1200 may also include: a power component 1226 configured to perform power management of the communication device 1200, a wired or wireless network interface 1250 configured to connect the communication device 1200 to the network, and an input/output (I/O) interface 1258. The communication device 1200 may operate an operating system stored in the memory 1232, such as Windows Server™, Mac OS X™, Unix™, Linux™, FreeBSD™, or the like.

Other embodiments of the present disclosure will be apparent to those skilled in the art from consideration of the specification and practice of the present disclosure disclosed here. The present disclosure is intended to cover any variations, uses, or adaptations of the present disclosure following the general principles thereof and including the common general knowledge or habitual technical means in the technical field not disclosed in the present disclosure. The specification and embodiments are considered as exemplary only, and a true scope and spirit of the present disclosure is indicated by the appending claims.

It will be appreciated that the present disclosure is not limited to the exact construction that has been described above and illustrated in the accompanying drawings, and that various modifications and changes may be made without departing from the scope thereof. It is intended that the scope of the present disclosure only be limited by the appended claims.

What is claimed is:

1. A method for determining a paging group, performed by a first network device, and comprising:
determining paging group assistance information by negotiating with a second network device, wherein the paging group assistance information is configured to determine a paging group of a terminal.

2. The method according to claim 1, wherein the paging group assistance information comprises at least one of:
quantity information indicating a total number of groups;
identification information indicating a group identity; and
paging probability information indicating a paging probability corresponding to a group.

3. The method according to claim 1, wherein the determining the paging group assistance information by negotiating with the second network device comprises:
determining the paging group assistance information with the second network device according to a protocol agreement.

4. The method according to claim 3, wherein the method further comprises:
determining, according to the protocol agreement, a total number of paging groups by negotiating with the second network device.

5. The method according to claim 3, wherein the determining the paging group assistance information with the second network device according to the protocol agreement comprises:
determining, according to the protocol agreement, group identity information of a specified type of terminal by negotiating with the second network device.

6. The method according to claim 3, wherein the determining the paging group assistance information with the second network device according to the protocol agreement comprises:
determining, according to the protocol agreement, paging probability information corresponding to the paging group of the terminal by negotiating with the second network device.

7. The method according to claim 1, wherein the determining the paging group assistance information by negotiating with the second network device comprises:
determining, with a non UE-associated signaling, the paging group assistance information by negotiating with the second network device.

8. The method according to claim 7, wherein the first network device is a core network device, and the second network device is an access network device; and
the determining, with the non UE-associated signaling, the paging group assistance information by negotiating with the second network device comprises:
during establishment of a NG interface between a radio access network and a core network, sending, by the first network device, the paging group assistance information to the second network device through a NG establishment response signaling, wherein the NG establishment response signaling is the non UE-associated signaling.

9. The method according to claim 8, wherein the sending, by the first network device, the paging group assistance information to the second network device through the NG establishment response signaling comprises:
sending, by the first network device, the paging group assistance information to a plurality of access network devices in a Tracking Area (TA) or a Routing Area (RA) of the first network device through the NG establishment response signaling.

10. The method according to claim 7, wherein the first network device is an access network device, and the second network device is a core network device; and
the determining, with the non UE-associated signaling, the paging group assistance information by negotiating with the second network device comprises:
during establishment of a NG interface, sending, by the first network device, the paging group assistance information to the second network device by using a NG establishment request signaling, wherein the NG establishment request signaling is the non UE-associated signaling.

11. The method according to claim 1, wherein the first network device comprises an access network device accessed by the terminal after switching a cell, and the second network device is an access network device accessed by the terminal before switching the cell.

12. The method according to claim 11, wherein the determining the paging group assistance information by negotiating with the second network device comprises:
determining, by the first network device, the paging group assistance information according to a switch request message sent by the second network device, wherein the paging group assistance information is carried by the switch request message.

13. The method according to claim 12, wherein the switch request message comprises:
the paging group assistance information reported by the terminal that is received by the second network device;
and/or
the paging group assistance information obtained by the second network device from a core network device.

14. The method according to claim 11, wherein the first network device is an access network device accessed by an inactive terminal after reselecting a cell, and the second network device is an anchor access network device accessed by the inactive terminal before reselecting the cell.

15. The method according to claim 14, wherein the determining the paging group assistance information by negotiating with the second network device comprises:
determining, by the first network device, the paging group assistance information according to context response information of the terminal sent by the second network device, wherein the paging group assistance information is carried in the context response information of the terminal.

16. The method according to claim 1, wherein the first network device is an access network device accessed by the terminal after switching a cell, and the second network device is a core network device.

17. The method according to claim 16, wherein the determining the paging group assistance information by negotiating with the second network device comprises:
sending, by the first network device, a path switch request to the second network device, wherein the path switch request is configured to request the second network device to send the paging group assistance information; and
receiving, by the first network device, a path switch response sent, according to the path switch request, by the second network device, wherein the paging group assistance information is carried in the path switch response.

18. The method according to claim 17, wherein the path switch request comprises flag information requesting the paging group assistance information.

19. The method according to claim 18, wherein the paging group assistance information is carried in the path switch response of the core network device based on a protocol agreement;
or
the paging group assistance information is carried in the path switch response of the core network device based on the flag information.

20. An apparatus for determining a paging group, comprising:
a transceiver module, configured to determine paging group assistance information by negotiating with a second network device, wherein the paging group assistance information is configured to determine a paging group of a terminal.

21. The apparatus according to claim 20, wherein the paging group assistance information comprises at least one of:
quantity information indicating a total number of groups;
identification information indicating a group identity; and
paging probability information indicating a paging probability corresponding to a group.

22. The apparatus according to claim 20, wherein the transceiver module is specifically configured to:
determine the paging group assistance information with the second network device according to a protocol agreement.

23. The apparatus according to claim 22, wherein the transceiver module is specifically configured to:
determine, according to the protocol agreement, a total number of paging groups by negotiating with the second network device.

24. The apparatus according to claim 22, wherein the transceiver module is specifically configured to:
determine, according to the protocol agreement, group identity information of a specified type of terminal by negotiating with the second network device.

25. The apparatus according to claim 22, wherein the transceiver module is specifically configured to:
determine, according to the protocol agreement, paging probability information corresponding to the paging group of the terminal by negotiating with the second network device.

26. The apparatus according to claim 20, wherein the transceiver module is specifically configured to:
determine, with a non UE-associated signaling, the paging group assistance information by negotiating with the second network device.

27. The apparatus according to claim 26, wherein the apparatus is a core network device, and the second network device is an access network device; and
the transceiver module is further configured to:
during establishment of a NG interface between a radio access network and a core network, send the paging group assistance information to the second network device through a NG establishment response signaling, wherein the NG establishment response signaling is the non UE-associated signaling.

28. The apparatus according to claim 27, wherein the transceiver module is further configured to:
send the paging group assistance information to a plurality of access network devices in a Tracking Area (TA) or a Routing Area (RA) of the apparatus through a NG establishment response signaling.

29. The apparatus according to claim 26, wherein the apparatus is an access network device, and the second network device is a core network device; and
the transceiver module is further configured to:
during establishment of a NG interface, send the paging group assistance information to the second network device by using a NG establishment request signaling, wherein the NG establishment request signaling is the Non UE-associated signaling.

30. The apparatus according to claim 20, wherein the apparatus comprises an access network device accessed by the terminal after switching a cell, and the second network device is an access network device accessed by the terminal before switching the cell.

31. The apparatus according to claim 30, wherein the transceiver module is further configured to:
determine the paging group assistance information according to a switch request message sent by the second network device, wherein the paging group assistance information is carried by the switch request message.

32. The apparatus according to claim 31, wherein the switch request message comprises:
the paging group assistance information reported by the terminal that is received by the second network device;
and/or
the paging group assistance information obtained by the second network device from a core network device.

33. The apparatus according to claim 30, wherein the apparatus is an access network device accessed by an inactive terminal after reselecting a cell, and the second network device is an anchor access network device accessed by the inactive terminal before reselecting the cell.

34. The apparatus according to claim 33, wherein the transceiver module is further configured to:
determine the paging group assistance information according to context response information of the terminal sent by the second network device, wherein the paging group assistance information is carried in the context response information of the terminal.

35. The apparatus according to claim 20, wherein the apparatus is an access network device accessed by the terminal after switching a cell, and the second network device is a core network device.

36. The apparatus according to claim 35, wherein the transceiver module is further configured to:
send a path switch request to the second network device, wherein the path switch request is configured to request the second network device to send the paging group assistance information; and
receive a path switch response sent, according to the path switch request, by the second network device, wherein the paging group assistance information is carried in the path switch response.

37. The apparatus according to claim 36, wherein the path switch request comprises flag information requesting the paging group assistance information.

38. The apparatus according to claim 37, wherein the paging group assistance information is carried in the path switch response of the core network device based on a protocol agreement;
or
the paging group assistance information is carried in the path switch response of the core network device based on the flag information.

39. A communication device, wherein the communication device comprises at least: a processor and an interface circuit;
the interface circuit is configured to receive code instructions and transmit them to the processor; and
the processor is configured to run the code instructions to perform a step in the method provided by any one of claims 1 to 19.

40. A computer-readable storage medium having computer-executable instructions stored thereon, which are configured to, when executed, implement a step in the method provided by any one of claims 1 to 19.
